(19) United States
(12) Patent Application Publication
(10) Pub. No.: US 2026/0346618 A1
(43) Pub. Date: Nov. 5, 2026

(54) PRINTER, PROGRAM, AND METHOD FOR CONTROLLING PRINTER

(71) Applicant: SATO HOLDINGS KABUSHIKI KAISHA, Tokyo (JP)

(72) Inventors: Fujio YOSHIDA, Tokyo (JP); Yuka NAKANISHI, Tokyo (JP)

(73) Assignee: SATO HOLDINGS KABUSHIKI KAISHA, Tokyo (JP)

(21) Appl. No.: 19/112,471

(22) PCT Filed: Oct. 30, 2023
(86) PCT No.: PCT/JP2023/039014

§ 371 Date: Mar. 17, 2025

(30) Foreign Application Priority Data
Nov. 22, 2022 (JP) 2022-186505
Oct. 27, 2023 (JP) 2023-184545

(51) Int. Cl. B41J 3/46; B41J 3/407; B41J 11/00; B41J 11/42

(52) U.S. Cl. CPC B41J 3/46; B41J 3/4075; B41J 11/0095; B41J 11/42

(57) ABSTRACT

One aspect of the present invention provides a printer including: a feed unit that sequentially feeds a plurality of print media toward an outlet; a printing unit that prints print information on each of a plurality of the print media; a control unit that controls the feed unit and the printing unit in such a way as to feed the printed print medium until the printed print medium becomes exposed from the outlet and print the print information on the next print medium when the printed print medium exposed from the outlet has been removed; and a voice output unit. The control unit controls the voice output unit in such a way as to output, as voice, at least a part of the print information or information related to the print information when the printed print medium exposed from the outlet has been removed.

### FIELD

The present invention relates to a printer, a program, and a method for controlling a printer.

### BACKGROUND

Conventionally, a known printer prints information on each of a plurality of labels peelably attached to a liner, peels the printed label from the liner, and discharges the printed label.

For example, Japanese Patent Application Laid-Open Publication No. 2018-034815 describes a printer that includes a peeling unit provided on a front side of a platen roller. The printer feeds a print medium including a liner and a plurality of labels temporarily attached to the liner. The printer changes a feed direction of the liner at the peeling unit, thereby peeling the printed label at the peeling unit and discharging the label alone.

### BRIEF SUMMARY

### Technical Problem

Incidentally, when a label issued (discharged) by a printer is attached to a product, there is a case where the label is mistakenly attached to a product different from a product to which the label is originally intended to be attached. For example, when labels with different printed contents are attached to a large number of different types of food products at a back area of a store such as a retail store, there is a case where the certain label is attached to the food product different in the type from the food product to which the label is originally intended to be attached.

In view of the above, an object of the present invention is that a print medium printed by a printer is unlikely to be attached to an attachment target mistakenly.

### Solution to Problem

One aspect of the present invention provides a printer including:
a feed unit that sequentially feeds a plurality of print media toward an outlet;
a printing unit that prints print information on each of a plurality of the print media;
a control unit that controls the feed unit and the printing unit in such a way as to feed the printed print medium until the printed print medium becomes exposed from the outlet and print the print information on the next print medium when the printed print medium exposed from the outlet has been removed; and
a voice output unit, wherein
the control unit controls the voice output unit in such a way as to output, as voice, at least a part of the print information or information related to the print information when the printed print medium exposed from the outlet has been removed.

### Advantageous Effects

According to an aspect of the present invention, it become possible that a print medium printed by a printer is unlikely to be attached to an attachment target mistakenly.

### BRIEF DESCRIPTION OF DRAWINGS

FIG. 1 is a perspective view of a printer according to one embodiment when a printer cover is at a closing position.

FIG. 2 is a perspective view of the printer according to one embodiment when the printer cover is at an opening position.

FIG. 3 illustrates a feed path for a continuous sheet when a label is peeled and issued in the printer according to one embodiment.

FIG. 4 illustrates label peeling and issuing operation in the printer according to one embodiment.

FIG. 5 illustrates a configuration example of data of a call table stored in the printer according to one embodiment.

FIG. 6 illustrates a change of a displayed image when a label is issued by a label printing application in the printer according to one embodiment.

FIG. 7 illustrates a displayed image when a label is issued by the label printing application, and one example of a printed label, in the printer according to one embodiment.

FIG. 8 illustrates a change of a displayed image when a speech function is set by the label printing application in the printer according to one embodiment.

FIG. 9 illustrates a change in a displayed image when the speech function is set by the label printing application in the printer according to one embodiment.

FIG. 10 is a block diagram illustrating an internal configuration of the printer according to one embodiment.

FIG. 11 is a flowchart that represents peeling-and-issuing processing executed by the printer according to one embodiment.

FIG. 12 illustrates the peeling-and-issuing processing for labels when a liner-less label is applied to the printer according to one embodiment.

### DETAILED DESCRIPTION

The following describes one embodiment of a printer, a program, and a printer control method according to the present invention. The below-described configurations are not limited to those in the drawings described in the brief description of the drawings.

A first aspect of the present invention is a printer including:
a feed unit that sequentially feeds a plurality of print media toward an outlet;
a printing unit that prints print information on each of a plurality of the print media;
a control unit that controls the feed unit and the printing unit in such a way as to feed the printed print medium until the printed print medium becomes exposed from the outlet and print the print information on the next print medium when the printed print medium exposed from the outlet has been removed; and
a voice output unit, wherein
the control unit controls the voice output unit in such a way as to output, as voice, at least a part of the print information or information related to the print information when the printed print medium exposed from the outlet has been removed.

According to the first aspect of the present invention, at least a part of the print information printed on the print medium picked up by a user of the printer, or the information related to the print information is output as voice. For this reason, it becomes unlikely that the user attaches the print medium to an attachment target mistakenly.

A second aspect of the present invention is a printer according to the first aspect, including a sensor that detects presence or absence of a print medium exposed from the outlet, in which when a detection result of the sensor changes from presence of the print medium to absence of the print medium, the control unit determines that the printed print medium has been removed.

According to the second aspect of the present invention, using the sensor enables removal of the printed print medium to be reliably detected.

A third aspect of the present invention is the printer according to the first or second aspect, in which the control unit controls the voice output unit to output, as voice, information added based on an operation input from a user.

According to the third aspect of the present invention, the user can customize contents of the voice output to be contents easily recognizable for the user.

A fourth aspect of the present invention is the printer according to any one of the first to third aspects, in which when a predetermined time length has not been elapsed since the voice output unit outputs the voice, in printing the print information a plurality of times, the control unit controls the voice output unit in such a way as not to output next voice.

According to the fourth aspect of the present invention, when the user frequently removes the print medium from the printer, the voice is not output each time of the removal. Thus, the user is relieved from being disturbed.

A fifth aspect of the present invention is the printer according to the fourth aspect, in which the control unit sets the predetermined time length, based on an operation input from a user.

According to the fifth aspect of the present invention, the predetermined time length (i.e., a time length during which the voice output is prevented) can be changed based a preference of the user.

A sixth aspect of the present invention is a printer according to any of the first to fifth aspects, in which the print information includes information relating to a name, expiration, and a price of a product, and the control unit controls the printer to output, as voice, at least one of the name, the expiration, and the price.

According to the sixth aspect of the present invention, when the print medium is attached to a product, voice of at least one of the name, the expiration, and the price of the product is output. For this reason, it becomes unlikely that the user attaches the print medium to an attachment target mistakenly.

A seventh aspect of the present invention is a program for a printer that sequentially feeds a plurality of print media toward an outlet and performs printing on the print media, the program causing a computer to execute:
a step of instructing the printer to perform printing of print information on the print medium;
a step of instructing the printer to feed the printed print medium until the printed print medium becomes exposed from the outlet;
a step of instructing the printer to output, as voice, at least a part of the print information or information related to the print information when the printed print medium exposed from the outlet has been removed; and
a step of instructing the printer to print the print information on the next print medium when the printed print medium exposed from the outlet has been removed.

According to the seventh aspect of the present invention, at least a part of the print information printed on the print medium picked up by a user of the printer, or the information related to the print information is output as voice. For this reason, it becomes unlikely that the user attaches the print medium to an attachment target mistakenly.

An eighth aspect of the present invention is a method for controlling a printer that sequentially feeds a plurality of print media toward an outlet and performs printing on the print media, the method including:
printing print information on the print medium;
feeding the printed print medium until the printed print medium becomes exposed from the outlet;
outputting, as voice, at least a part of the print information or information related to the print information when the printed print medium exposed from the outlet has been removed; and
printing the print information on the next print medium when the printed print medium exposed from the outlet has been removed.

According to the eighth aspect of the present invention, at least a part of the print information printed on the print medium picked up by a user of the printer, or the information related to the print information is output as voice. For this reason, it becomes unlikely that the user attaches the print medium to an attachment target mistakenly.

A ninth aspect of the present invention is the printer according to any one of the first to sixth aspects, in which when a second character string is added, based on an operation input from a user, in association with the first character string included in at least a part of the print information to be output as voice, the control unit controls the printer in such a way as to output the second character string as voice instead of the first character string at the time of outputting at least a part of the print information as voice.

According to the ninth aspect of the present invention, the user can customize a voice output mode for the print information to be output as voice. For example, when the print information includes, as the first character string, a Chinese character whose pronunciation is difficult, the user can add hiragana or katakana as the second character string expressing the pronunciation of the Chinese character. Thereby, the voice can be prevented from being output with erroneous pronunciation.

The following describes a printer 1 according to one embodiment of the present invention, with reference to the drawings.

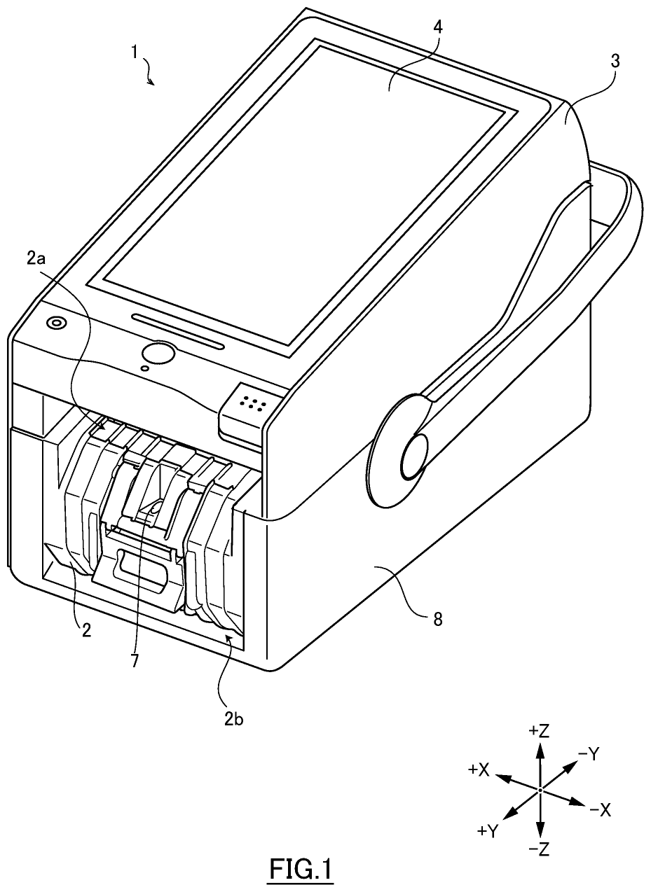

First, a structure of the printer 1 will be described with reference to FIG. 1 to FIG. 3.

The XYZ axes are defined in FIG. 1 to FIG. 3, for convenience of describing the printer 1. Specifically, the left and right directions of printer 1 are defined as the +X and −X axes, respectively; the front and back directions as the +Y and −Y axes, respectively; and the upward and downward directions as the +Z and −Z axes, respectively.

As illustrated in FIG. 1 to FIG. 3, the printer 1 includes a front panel 2, a printer cover 3, a display panel 4, an accommodation unit 6, a housing 8, a platen roller 10, a thermal head 12, a first auxiliary roller 13, a second auxiliary roller 14, and a peeling unit 15.

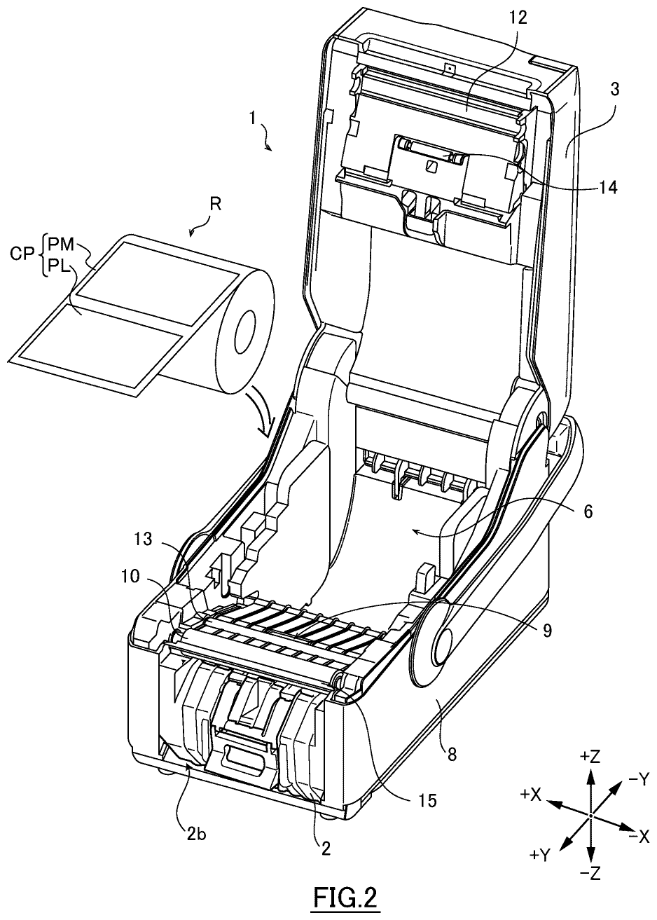

FIG. 2 illustrates rolled sheet R accommodated in the accommodation unit 6 of the printer 1. The rolled sheet R is a rolled continuous sheet CP. The continuous sheet CP includes a belt-shaped liner PM and a plurality of labels PL peelably attached to the liner PM with an adhesive. A plurality of the labels PL are attached at equal intervals on the liner PM. Although not illustrated in the drawings, reference marks are formed at predetermined intervals on a back surface of the liner PM. The reference mark indicates a reference position of the label PL.

The label PL includes a substrate, a thermosensitive color development layer formed on a printed-surface side of the substrate, and an adhesive layer coated on a back-surface side of the substrate.

As illustrated in FIG. 1 and FIG. 2, the printer cover 3 can swing between a closing position (FIG. 1) and an opening position (FIG. 2), about a shaft provided on a back side of the housing 8. When the printer cover 3 is at the opening position, the accommodation unit 6 is exposed so that the rolled sheet R can be accommodated into the accommodation unit 6.

As illustrated in FIG. 1, when the printer cover 3 is at the closing position, a label outlet 2a is formed in a front surface of the printer 1 by a gap between the printer cover 3 and the housing 8. The front panel 2 is attached to a front surface of the housing 8.

The printer cover 3 is provided with the display panel 4. The display panel 4 is configured to display information relating to the printer 1, and an operation key image. When the user touches the operation key image, the printer 1 receives an instruction associated with the operation key image. The display panel 4 is, for example, a liquid crystal display including a touch sensor.

As illustrated in FIG. 2, the platen roller 10 is pivotally supported by the housing 8, and the thermal head 12 is attached to the printer cover 3. The platen roller 10 is coupled to a stepping motor (not illustrated in the drawings), and rotates depending on rotation of the motor. Thereby, the platen roller 10 feeds the continuous sheet CP pulled out from the rolled sheet R.

The thermal head 12 includes a heating unit including a plurality of heating elements (not illustrated in the drawings), and selectively causes a plurality of the heating elements to heat, and thereby cause the thermosensitive color development layer of the label PL to develop a color. Thus, information is printed on the label PL.

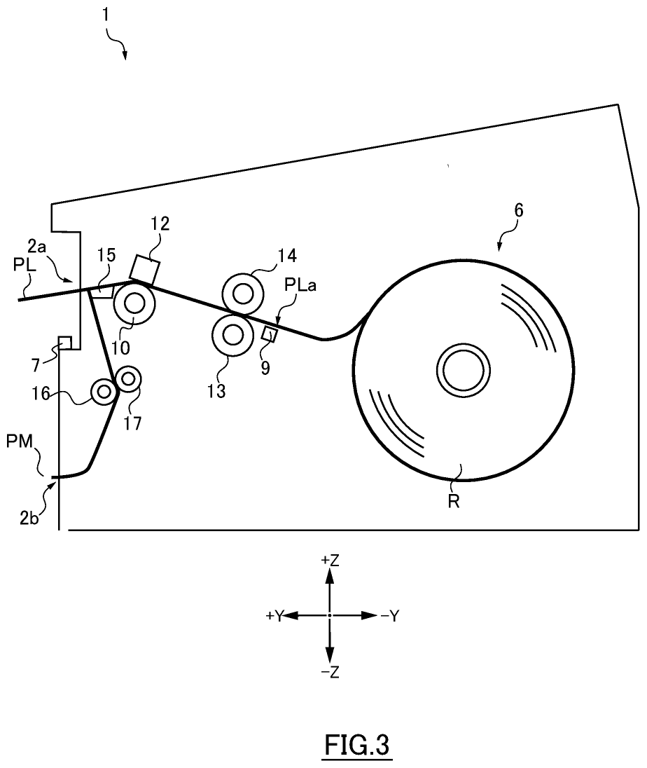

When the printer cover 3 is at the opening position, the platen roller 10 and the thermal head 12 are separated from each other. When the printer cover 3 is at the closing position, the platen roller 10 and the thermal head 12 are located to face each other in such a way as to hold the continuous sheet CP therebetween (refer to FIG. 3).

As illustrated in FIG. 2, the first auxiliary roller 13 is pivotally supported by the housing 8, and the second auxiliary roller 14 is rotatably arranged at the printer cover 3. As illustrated in FIG. 3, a first nip roller 16 and a second nip roller 17 are arranged to face each other inside the housing 8.

With reference to FIG. 3, the following describes the feed of the continuous sheet CP in a case of peeling and issuing the labels PL. The continuous sheet CP is pulled out from the rolled sheet R by rotation of the platen roller 10. At this time, the continuous sheet CP is fed while being held between the first auxiliary roller 13 and the second auxiliary roller 14. Information is printed by the thermal head 12 on the label PL of the continuous sheet CP.

The peeling unit 15 is arranged on a front side of the platen roller 10. The peeling unit 15 may have any structure that causes a path of the liner PM to be sharply turned. For example, the peeling unit 15 may be configured as a peeling plate or a peeling pin. As illustrated in FIG. 3, the liner PM of the continuous sheet CP is directed downward in the peeling unit 15, and is discharged from a liner outlet 2b while being held between the first nip roller 16 and the second nip roller 17. Meanwhile, the label PL on the liner PM is peeled from the liner PM in the peeling unit 15 without following the liner PM, and is discharged from the label outlet 2a arranged on an upper side of the liner outlet 2b.

As illustrated in FIG. 2 and FIG. 3, a mark detection sensor 9 is arranged in the housing 8, on an upstream side of the first auxiliary roller 13 in a feed path. The mark detection sensor 9 is a sensor for detecting the reference marks formed at the equal intervals on the back surface of the liner PM. The mark detection sensor 9 is constituted by a light reflection type optical sensor, for example.

As illustrated in FIG. 1 and FIG. 3, a removal sensor 7 is arranged in the housing 8, on a lower side of the label outlet 2a. The removal sensor 7 is a sensor for detecting presence or absence of the label PL at the label outlet 2a. The removal sensor 7 is constituted by a light reflection type optical sensor, for example.

When a result of detection by the removal sensor 7 changes from “label presence” to “label absence”, it is determined in the printer 1 that the printed label has been removed by a user. Using the removal sensor 7 enables reliable detection of removal of the printed label.

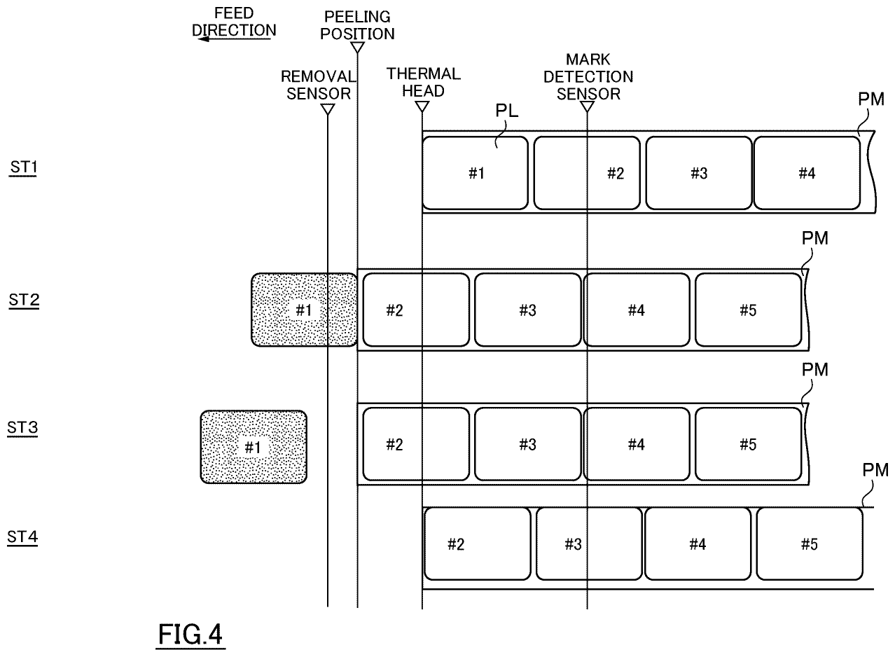

Next, operation of the printer 1 for the peeling and issuing will be described with reference to FIG. 4.

FIG. 4 illustrates the label peeling-and-issuing operation in the printer 1. In this drawing, labels PL #1, #2, #3, #4, . . . are arranged in this order on the liner PM, and a predetermined number of labels are assumed to be sequentially peeled and issued, starting with the label PL #1.

First in the peeling and issuing, the first label PL #1 is printed in a state ST1. A leading end of the first label PL #1 can be positioned at the heating unit of the thermal head 12 by feeding the continuous sheet by a predetermined distance from the time the mark detection sensor 9 detects the reference mark formed on the back surface of the liner PM. The predetermined distance is determined by a position of the reference mark and a position of the leading end of the label PL.

After printing on the label PL #1 is completed, the continuous sheet is fed. Thereby, the label PL #1 is peeled from the liner PM and discharged and thus become exposed from the label outlet 2a, as illustrated in a state ST2. A distance by which the continuous sheet is fed after the printing on the label PL #1 is completed is a distance preset in such a way that the discharged label becomes exposed by a predetermined amount from the label outlet 2a.

The removal sensor 7 constantly detects presence or absence of the label PL #1 (i.e., whether the label PL #1 has been removed). The label PL #1 is removed by the user as illustrated in a state ST3. In response to this, the printer 1 positions a leading end of the second label PL #2 at the heating unit of the thermal head 12 (state ST4) by backward feeding (feeding in the opposite direction), in order to print the next label PL #2.

Repeating the above-described operation causes the new label to be printed and discharged each time the user removes the label that has been discharged from the printer 1. Thus, the peeling and issuing enables the user to sequentially attach the discharged labels to a plurality of products.

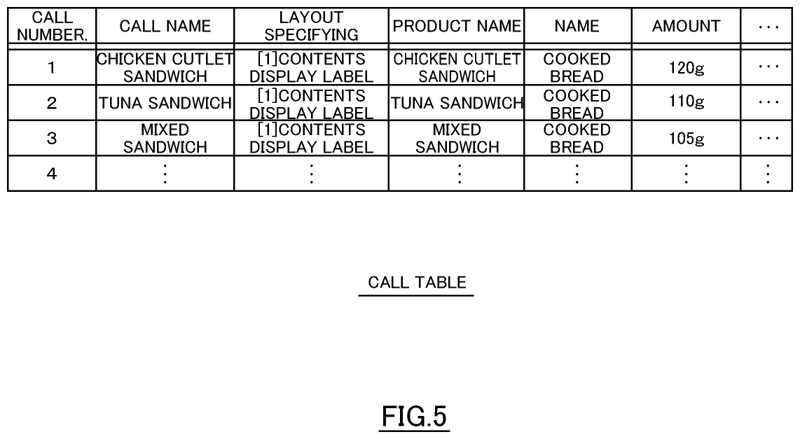

Next, label issuing by a label printing application will be described with reference to FIG. 5 to FIG. 7.

The printer 1 stores a plurality of format files (one example of print information) that include information of print layouts and print contents specialized for a plurality of respective products (items) that are attachment targets of the labels PL. The printer 1 stores a call table including a plurality of the format files.

FIG. 5 illustrates an example of a data structure of the call table including a plurality of format files.

Each record in the call table is associated with one format file, and includes values in respective fields of “call no.”, “call name”, “layout specifying”, “product name”, “name”, “amount”, . . . . The field of “layout specifying” includes a value that represents the print layout of the label, while specific layout data associated with this value are defined separately. A value of each of the fields “product name”, “name”, “amount”, . . . is a specific character string (the character string printed on the print layout) applied to the print layout. Values of the fields of “call no.” and “call name” are collated at the time of calling the format file (i.e. calling the item).

A label issuing application for assisting the user in printing the labels is installed in the printer 1. The user selects the item on the label issuing application, and thereby causes the printer 1 to read out, from the call table, the format file associated with the selected item, generate drawing data, based on the read-out format file, and performs the printing on the labels PL.

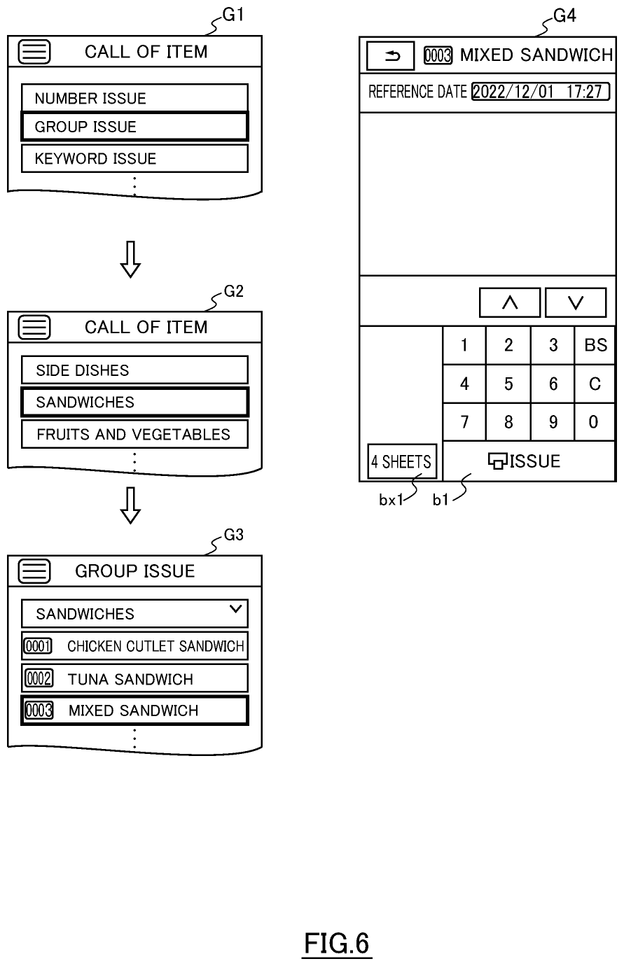

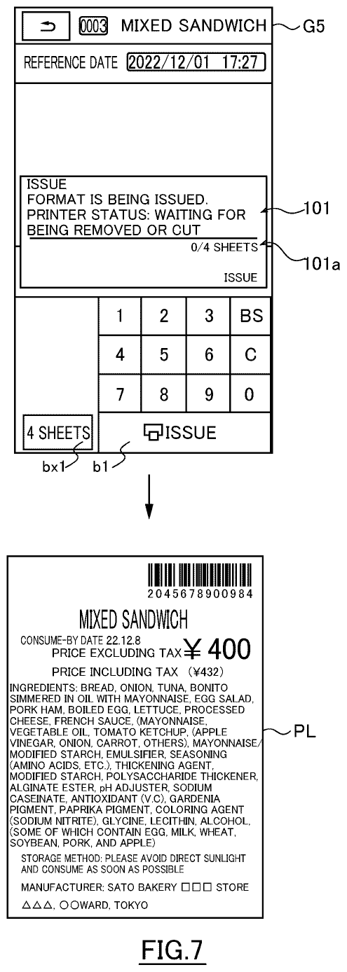

FIG. 6 and FIG. 7 illustrate an operation procedure when the user selects the item in the printer 1 and thereby causes the labels to be printed. With reference to FIG. 6 and FIG. 7, the following describes the procedure for issuing the labels by the printer 1 using the label printing application.

The user can select one of “number issue”, “group issue”, and “keyword issue” on an item call image G1 of the label issuing application. “Number issue” is a method in which a call number is specified to call the item. “Group issue” is a method in which a group is specified to call the item when the items are hierarchized by groups. “Keyword issue” is a method in which a part of a product name for example is specified to search for the matching item and call the item.

Selecting “group issue” on the image G1 in FIG. 6 causes a group of a plurality of the items to be presented on an image G2. Here, selecting the group of “sandwich” causes an image G3 to be displayed. The image G3 includes a list of a plurality of the items included in this group. Selecting the item of “mixed sandwich” on the image G3 causes an image G4 to be displayed for issuing the label associated with the item. The image G4 includes an input box bx1 and an issue button b1. The input box bx1 is provided for the user to specify the number of labels to be issued.

Operating the issue button b1 on the image G4 starts printing of labels whose number has been specified in the input box bx1. An image G5 in FIG. 7 represents an example of the image during the peeling and issuing of the labels. The image G5 includes status information 101. The status information 101 includes information such as information indicating that the peeling and issuing is currently in progress and the label is waiting to be cut (i.e., indicating the state ST2 in FIG. 4). FIG. 7 illustrates the label PL issued when “mixed sandwich” is selected as the item.

The status information 101 includes a number-of-sheets count 101a. The number-of-sheets count 101a indicates the sequence number of the currently issued label among all the labels (four labels in the example of FIG. 7) to be issued. The user can set whether to cause the number-of-sheets count 101a to be displayed in the label issuing application during the peeling and issuing. When the number-of-sheets count 101a is displayed, the printer 1 monitors the number of the already issued labels and the number of the labels yet to be issued.

In one embodiment, the label issuing application causes a voice (speech) to be output at an appropriate timing in the label peeling and issuing. The speech contents include at least a part of the format file of the item associated with the label to be issued.

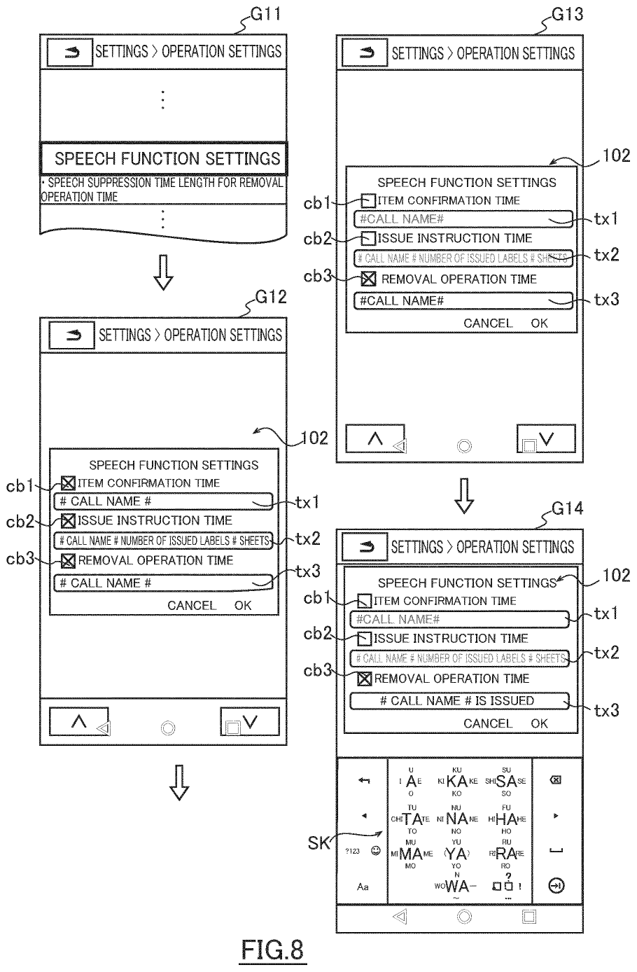

FIG. 8 illustrates a series of displayed images relating to a method of setting the speech at the time of peeling and issuing the labels by the printer 1 using the label printing application. Selecting “operation settings” from a setting menu of the label issuing application causes an image G11 in FIG. 8 to be displayed. Selecting “speech function settings” from various types of the operation settings on the image G11 causes an image G12 to be displayed. The image G12 includes a setting window 102 for the speech function settings.

The setting window 102 includes “item confirmation time”, “issue instruction time”, and “removal operation time” as timings for outputting speech, and includes the check boxes cb1, cb2, and cb3 associated with these respective timings. Whether to output speech at each of these timings can be set by the associated check box cb1, cb2, or cb3. Here, “removal operation” means user's operation of removing the label that has been exposed by being discharged from the printer 1.

The check box in an on-state indicates that the speech will be output. The check box in an off-state indicates that the speech will not be output.

The setting window 102 includes editable text boxes tx1, tx2, and tx3 in which the contents to be spoken are written in association with the respective check boxes. For example, the text box tx1 set as “#call name #” for “item confirmation time” indicates that the call name (refer to FIG. 5; “mixed sandwich” or the like) associated with the item will be spoken as the contents at the item confirmation time.

This example represents a case where the speech contents include a value included in the format file and associated with the character string sandwiched between #and #and includes a value indicating the number of issued sheets. However, a rule for specifying speech contents is not limited to such sandwiching of the speech contents, and can be appropriately defined.

In the example of the settings made via the setting window 102 on the image G12, the printer 1 outputs speech of “mixed sandwich” (call name) at the time (“item confirmation time”) that the item “mixed sandwich” is selected on the image G4 in FIG. 6. The printer 1 outputs speech of “mixed sandwich, four sheets” (call name +number of issued labels +sheets) at the time (“issue instruction time”) that the print button b1 is operated on the image G4 in FIG. 6. The printer 1 outputs speech of “mixed sandwich” (call name) each time (“removal operation time”) the exposed label is removed as represented by the states ST3 and ST4 in FIG. 4.

Particularly, when the setting has been made in such a way as to output the speech at the removal operation time, the contents of the product associated with the label are spoken at the working time of attaching, to the product, the label removed from the printer 1. For this reason, it becomes unlikely that the user attaches the label to an attachment target product mistakenly.

Changing each of the check boxes cb1 and cb2 from an on-state to an off-state by user operation on the image G12 causes an image G13 to be displayed. The image G13 represents a setting example when speech is output only at “removal operation time”.

In one embodiment, the user can change speech contents by editing the text boxes tx 1, tx2, and tx3. For example, selecting the text box tx3 on the image G13 causes an image G14 to be displayed. The image G14 includes a software keyboard SK for changing the contents of the selected text box tx3. The image G14 is an example in which the contents of the text box tx3 have been changed from “#call name #” to “#call name #is issued”. With this change, speech of “mixed sandwich is issued” for example is output each time the label is peeled and issued.

Here, the text “is issued” corresponds to the information added based on the operation input from the user. In other words, the information added based on the operation input from the user is spoken in addition to the call name that is a part of the format file. Thus, the user can customize the speech contents to be contents easily recognizable for the user.

In one embodiment, the label issuing application allows a speech suppression time length (hereinafter, appropriately referred to as “speech suppression time length”) for the removal operation time to be set relating to speech at the removal operation time. The speech suppression time length means a time length during which next speech is suppressed or prohibited from the time speech is last output, in the case where the speech is set in such a way as to be output at the removal operation time. In other words, in the case where the speech suppression time length is set, the printer 1 controls next speech in such a way as not to be output when the speech suppression time length has not elapsed since the printer 1 last outputs the speech. Setting the speech suppression time length prevents the speech from being output each time the user removes the label, in a case where the printer 1 peels and issues a plurality of the labels and the user frequently (i.e., in a relatively short period of time) and sequentially removes the respective labels and attaches the removed labels to the products. Thus, the user is relieved from being disturbed by the frequent output of the speech.

A starting point of the speech suppression time length may be the time when the label is removed or the time when the label is printed (the printing is completed), instead of the time when the speech is output. In other words, the printer 1 may control speech associated with the next issued label in such a way as not to be output when the speech suppression time length has not elapsed since the label is last removed, or may control speech associated with the next issued label in such a way as not to be output when the speech suppression time length has not elapsed since the label is last printed.

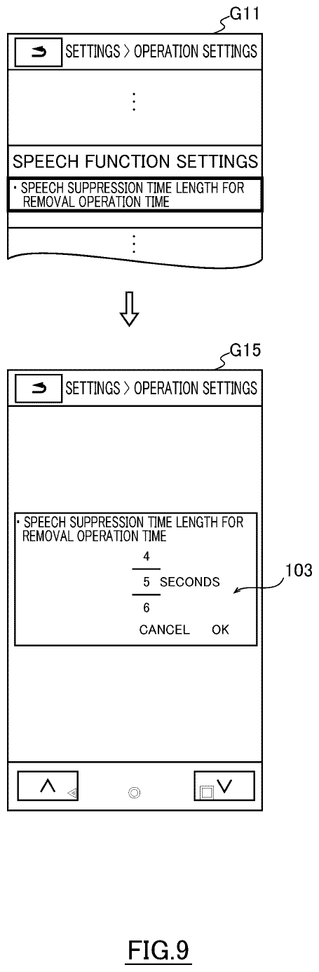

FIG. 9 illustrates a method for setting the speech suppression time length in the label issuing application.

The image G11 in FIG. 9 is the same as the image G11 in FIG. 8. Selecting “speech suppression time length for removal operation time” on this image causes an image G15 to be displayed. The image G15 includes a setting window 103 for selecting the speech suppression time length from a plurality of time lengths and thereby setting the selected speech suppression time length. The example of the setting window 103 in FIG. 9 includes four seconds, five seconds, and six seconds as options, but the user can set any time length by scrolling operation. In other words, the speech suppression time length can be changed depending on a preference of the user.

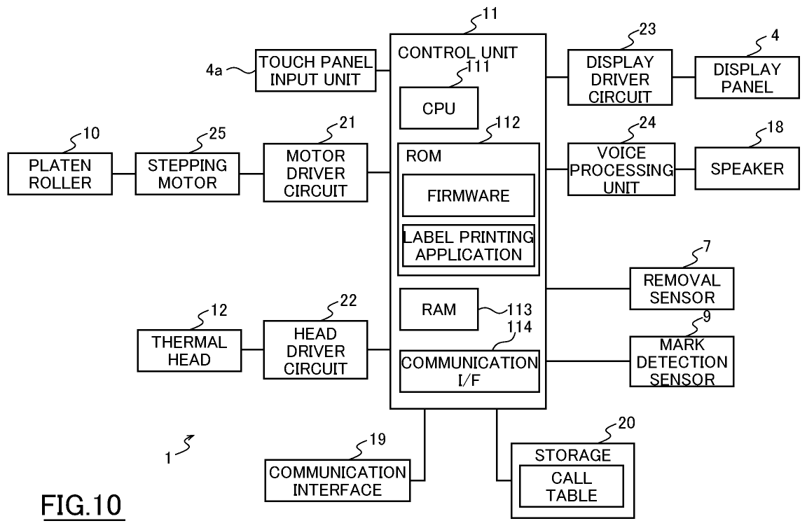

Next, a configuration for operating the printer 1 is described with reference to a block diagram of FIG. 10.

A control unit 11 includes a CPU 111, a ROM 112, and a RAM 113. The control unit 11 is connected to a touch panel input unit 4a, the removal sensor 7, the mark detection sensor 9, a communication interface 19, a storage 20, a motor driver circuit 21, a head driver circuit 22, a display driver circuit 23, and a voice processing unit 24. The control unit 11 controls each of these, depending on execution results of firmware and the label issuing application.

The firmware successively generates status information, based on an operation input from the user to the touch panel input unit 4a, a state of the printer 1, detection results of the respective sensors, and the like. The status information represents a status of the printer 1.

The CPU 111 in the control unit 11 loads and executes the firmware and the label issuing application recorded in the ROM 112, and thereby implements various functions. The ROM 112 is a non-volatile memory. For example, the ROM 112 is a solid state drive (SSD) such as a flash memory. The RAM 113 functions as a main memory for the CPU 111 performing various pieces of processing.

The communication interface 19 includes a communication circuit for communicating with an unillustrated host computer by a predetermined protocol. For example, the communication interface 19 receives the format files from the host computer.

The storage 20 is constituted by an SSD, for example, and stores the call table (refer to FIG. 5). When the control unit 11 receives the format file via the communication interface 19, the control unit 11 updates the call table in such a way as to generate a record associated with the received format file.

The motor driver circuit 21 rotates the stepping motor 25 in a forward direction or in a reverse direction by the number of steps included in a command of the firmware, thereby feeding the continuous sheet CP. The stepping motor 25 is coupled to the platen roller 10. The motor driver circuit 21, the stepping motor 25, and the platen roller 10 constitute one example of a feed unit.

When the firmware receives a print instruction, the firmware generates drawing data to be printed, based on the format file associated with the item selected by the user, and sequentially transmits respective pieces of line data of the drawing data to the head driver circuit 22. Based on the respective pieces of line data, the head driver circuit 22 causes electric current to flow selectively through a plurality of the heating elements included in the heating unit of the thermal head 12. Thereby, each of a plurality of the labels is printed. The head driver circuit 22 and the thermal head 12 constitute one example of a printing unit.

In the case of peeling and issuing the labels, the firmware controls the motor driver circuit 21 and the head driver circuit 22 in such a way that, when the printed label is fed until the printed label becomes exposed from the label outlet 2a, and the printed label exposed from the label outlet 2a has been removed, the next label is then printed. At this time, the firmware controls the motor driver circuit 21 in such a way that the continuous sheet is fed by the predetermined amount after the mark detection sensor 9 detects the reference mark on the liner. Thereby, a leading end of the label is positioned at the heating unit of the thermal head 12. When the firmware determines, based on a detection result of the removal sensor 7, that the discharged label has been removed, the firmware controls the motor driver circuit 21 in such a way that the continuous sheet is fed backward until the leading end of the next label coincides with the heating unit of the thermal head 12.

The touch panel input unit 4a is incorporated in the display panel 4. The touch panel input unit 4a detects an operation input made by the user to the display panel 4, and transmits the detected input to the control unit 11.

The display driver circuit 23 is a circuit that drives pixels, based on an image generated by the firmware or the label issuing application. The pixels constitute the display panel 4.

Under a command generated by the label issuing application, the voice processing unit 24 performs text-to-speech synthesis processing (TTS), based on the timing and the speech contents following the speech function settings. Thereby, the voice processing unit 24 generates voice data, and causes the speaker 18 to output the voice (speech). The voice processing unit 24 and the speaker 18 constitute one example of a voice output unit.

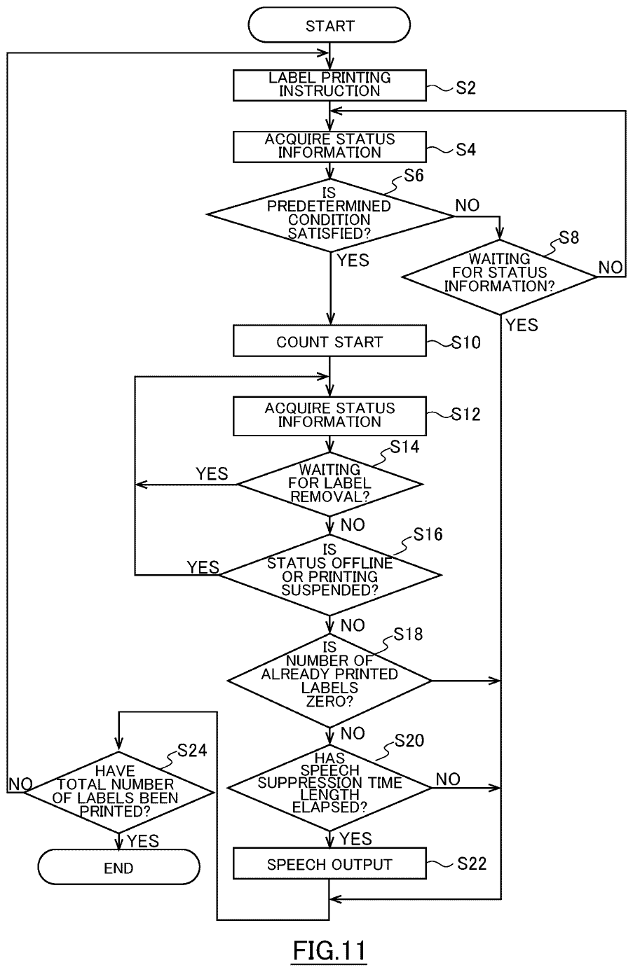

Next, operation of the printer 1 at the time of peeling and issuing the labels will be described with reference to a flowchart in FIG. 11. The flowchart in FIG. 11 represents the processing (label peeling-and-issuing processing) executed by the firmware and the label issuing application. In the following processing, it is assumed that the settings are made in such a way that speech is output only at the removal operation time.

When the label issuing application receives user operation (e.g., operation on the print button b1 in FIG. 6) (step S2), the label issuing application instructs the firmware to issue the labels. At this time point, the format file associated with the labels to be printed has been specified. The firmware generates the drawing data, based on the format file, and causes the first label to be issued.

Next, the label issuing application acquires the status information of the printer 1 from the firmware (step S4). When a predetermined condition is satisfied (step S6: yes), the label issuing application starts a count for monitoring the speech suppression time length (step S10).

The case where the predetermined condition at the step S6 is satisfied means that all of the following three conditions are satisfied, for example. When any one of these three conditions is not satisfied, the label issuing application acquires the new status information (step S8: no, step S4), and determines again whether all of the following three conditions are satisfied.
The speech setting for the removal operation time is made effective (i.e., the check box cb3 in FIG. 8 is in an on-state).
The display of the number-of-sheets count is made effective (the setting has been made in such a way as to display the number-of-sheets count 101a in FIG. 7).
The status of the printer 1 indicates that the label is yet to be removed.

After starting the count, the label issuing application acquires the status information again. Then, when the status indicates that the discharged label is yet to be removed (i.e., the label is waiting to be removed) (step S14: yes), the label issuing application successively acquires the status information and waits until the label is removed. Also when the status of the printer 1 indicates “offline” or “printing suspended” during the peeling operation (step S16: yes), similarly, the label issuing application successively acquires the status information and waits until the “offline” or “printing suspended” ceases.

When the label has been removed by the user (step S14: no), and the status of the printer 1 indicates an on-line state and does not indicate that printing is being suspended (step S16: no), the processing proceeds to the step S18. Here, when the number of the printed labels is not zero (step S18: no) and the speech suppression time length has elapsed since the count is started at the step S10 (step S20: yes), the label issuing application executes the speech output (step S22).

The status indicating “offline” at the step S16 means that the printer 1 is set offline by the user. The status indicating “printing suspended” at the step S16 means that the printer 1 is temporarily paused by operation of the user. A state where the number of the printed labels is zero at the step S18 is a state where a label (e.g., a previously printed different label) is being detected by the removal sensor 7 before the first label is printed in the peeling and issuing. Such conditions for the steps S16 and S18 are both irregular ones.
When the speech suppression time length has not elapsed (step S20: no), the speech is not output to prevent the frequent speech output from causing the disturbance, as described above,.
After the speech output, when the total number of labels are yet to be printed (issued) (step S24: no), the next label is issued (step S2). Meanwhile, after the speech output, when the total number of labels have been printed (step S24: yes), the processing of the label peeling-and-issuing ends.

As described above, in the case of peeling and issuing the labels, the printer 1 according to the present embodiment controls the speech output in such a way that the name or the like of the target product for attachment of the label is spoken as a part of the print information of the label when the user removes the printed label exposed from the label outlet 2a. For this reason, it becomes unlikely that the user attaches the label to an attachment target product mistakenly. In this case, when the user removes the printed labels successively at relatively short intervals, the frequent speech output can be prevented by setting the speech suppression time length.

In one embodiment, the call table (FIG. 5) includes one or both of the “expiration” field and the “price” field for each item. A value in the “expiration” field is a value of expiration (e.g., a consume-by date or a best-before date) of the product that is a target for attachment of the label. The value of the “price” field is a price value of the product. In this case, the label printing application may control at least one of the name, the expiration, and the price of the product to be spoken. Thereby, it becomes further unlikely that the user attaches the label removed from the printer 1 to an attachment target product mistakenly. For example, when labels are to be attached to a plurality of food ingredients that have the same product name but have different best-before dates, the speech output of the best-before date can prevent the label from being mistakenly attached.

For example, “#call name# #expiration# is issued” may be input in the check boxes cb1 to cb3 in FIG. 8.

When the information to be spoken includes a character string (e.g., a difficult Chinese character) difficult to be accurately spoken, the label issuing application may allow the user to register, in association with the character string, a character string (e.g., hiragana or katakana) relatively easy to be spoken, in order to enhance reliability of speech contents. For example, when a call name of an item is set to be spoken, and the call name in the call table is the specific Chinese characters that expresses cold chicken flavored with a sesame dressing and whose pronunciation is bang bang ji, there is a possibility that the specific Chinese characters are incorrectly spoken. For this reason, a “pronunciation” field associated with the call name is provided in the call table, and “bang bang ji” is registered in this field. Then, when “#call name [pronunciation]#” is input in the text box tx3 or the like in FIG. 8, the label printing application is set in such a way that the associated pronunciation “bang bang ji” is spoken instead of an incorrect pronunciation of the call name of the specific Chinese characters. Thereby, a character string difficult to be correctly spoken is prevented from being spoken with incorrect pronunciation.

In other words, in one embodiment, when a second character string is added based on an operation input from the user, in association with a first character string included in the information to be spoken, the control unit 11 of the printer 1 controls the second character string to be spoken instead of the first character string. Thus, the user can customize a speech output mode for the information to be spoken.

One embodiment provides a method for controlling the printer 1 that sequentially feeds a plurality of labels toward the label outlet 2a and performs printing on the labels, and the method includes the following steps (a) to (d). One embodiment provides a program for causing a computer to execute each of the following steps or processing of (a) to (d):
(a) the step of printing print information on the label;
(b) the step of feeding the printed label until the printed label becomes exposed from the label outlet 2a,
(c) the step of outputting, as voice, at least a part of the print information when the printed label exposed from the label outlet 2a is removed; and
(d) the step of printing the print information on the next label when the printed label exposed from the label outlet 2a is removed.

In the above-described embodiment, the liner-inclusive label as one application in the above-described case includes the liner and a plurality of labels peelably attached to the liner by the adhesive. However, there is no limitation to this. A liner-less label that does not include a liner can also be applied.

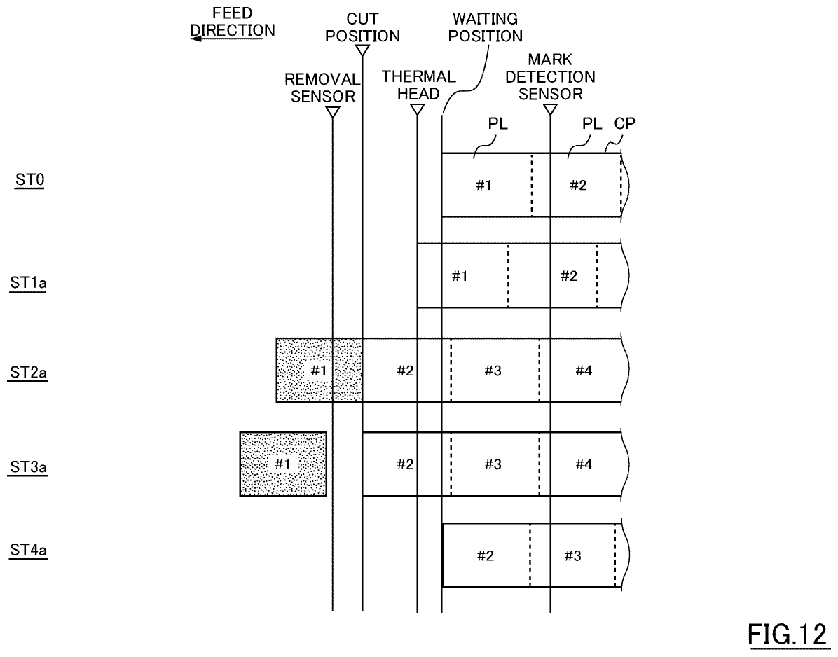

Operation of the printer 1 for issuing the liner-less label is described with reference to FIG. 12.

FIG. 12 illustrates the operation for issuing the liner-less label in the printer 1. In this drawing, labels PL #1, #2, #3, #4, . . . are arranged in this order while perforations are each provided at a boundary between the labels, and the labels are assumed to be sequentially issued, starting with PL #1. The respective labels do not need to be partitioned from each other by the perforation.

In a state ST0 before the liner-less label is issued, a leading end of the label PL #1 is at a waiting position on a slightly upstream side of the heating unit of the thermal head 12 in the feed direction. A distance between a position of the heating unit of the thermal head 12 and the waiting position is a predetermined value. Executing an issue instruction causes the continuous sheet CP to be fed in such a way that a leading end of the first label PL #1 is positioned at the heating unit of the thermal head 12, as illustrated in a state ST1a.

After printing on the label PL #1 is completed, the continuous sheet CP is fed. Thereby, the label PL #1 is discharged and thus become exposed, as illustrated in state ST2a. A distance by which the continuous sheet CP is fed after the printing on the label PL #1 is completed is a distance preset in such a way that the discharged label becomes exposed by a predetermined amount from the label outlet 2a.

The removal sensor 7 constantly detects presence or absence of the label PL #1 (i.e., whether the label PL #1 has been removed). The discharged and exposed label can be manually cut along the perforation. The label PL #1 is removed (cut) by the user as illustrated in a state ST3a. In response to this, the printer 1 positions a leading end of the second label PL #2 at the waiting position (state ST4a) by backward feeding (feeding in the opposite direction), in order to print the next label PL #2.

Here, in the case where the speech function settings are set in such a way as to output speech at the removal operation time, the call name (e.g., “mixed sandwich”) is spoken when the label PL #1 is removed by the user.

The above-described operation is repeated.

Although the embodiments of the printer, the program, and the printer control method according to the present invention are described above in detail, the scope of the present invention is not limited to the above-described embodiments. The above-described embodiments can be variously improved or modified within a range that does not depart from the essence of the present invention. The above-described embodiments and modified examples can be combined with each other.

In the above-described embodiment, the case of “at least a part of the print information is output as voice” is described above. For example, when the print information is “sweet bread product”, the information (voice output information) to be output as voice may be “sweet bread product” or may be “bread” as a part thereof. Even when the print information is encoded information such as a barcode, and the voice output information is a character string acquired by decoding the encoded information, at least a part of the print information can be considered substantially equivalent to the voice output information.

In one embodiment, information related to the print information may be output as voice. For example, when the print information is a character string “croissant”, and the voice output information is “sweet bread product” or “bread” as a term expressing a broader concept of “croissant”, the print information and the voice output information are related to each other. Even when such speech is output, it becomes unlikely that the user attaches the label to an attachment target product mistakenly.

The present invention is related to Japanese Patent Application No. 2022-186505 filed with the Japan Patent Office on Nov. 22, 2022, and Japanese Patent Application No. 2023-184545 filed with the Japan Patent Office on Oct. 27, 2023, and the entire contents of these patent applications are incorporated into the present description by reference.

1. A printer comprising:
a feed unit that sequentially feeds a plurality of print media toward an outlet;
a printing unit that prints print information on each of the plurality of print media;
a control unit that controls the feed unit and the printing unit in such a way as to feed a printed print medium until the printed print medium becomes exposed from the outlet and print the print information on the next print medium when the printed print medium exposed from the outlet has been removed; and
a voice output unit, wherein
the control unit controls the voice output unit in such a way as to output, as voice, at least a part of the print information or information related to the print information when the printed print medium exposed from the outlet has been removed.

2. The printer according to claim 1, comprising:
a sensor that detects presence or absence of a print medium exposed from the outlet, wherein
when a detection result of the sensor changes from presence of the print medium to absence of the print medium, the control unit determines that the printed print medium has been removed.

3. The printer according to claim 1, wherein
the control unit controls the voice output unit to output, as voice, information added based on an operation input from a user.

4. The printer according to claim 1, wherein
when a predetermined time length has not been elapsed since the voice output unit outputs the voice, in printing the print information a plurality of times, the control unit controls the voice output unit in such a way as not to output next voice.

5. The printer according to claim 4, wherein
the control unit sets the predetermined time length, based on an operation input from a user.

6. The printer according to claim 1, wherein
the print information includes information relating to a name, expiration, and a price of a product, and
the control unit controls the printer to output, as voice, at least one of the name, the expiration, and the price.

7. A non-transitory storage medium storing a program for a printer that sequentially feeds a plurality of print media toward an outlet and performs printing on the print media, the program, when installed in a computer, that causes the computer to execute:
a step of instructing the printer to perform printing of print information on the print medium;
a step of instructing the printer to feed the printed print medium until the printed print medium becomes exposed from the outlet;
a step of instructing the printer to output, as voice, at least a part of the print information or information related to the print information when the printed print medium exposed from the outlet has been removed; and
a step of instructing the printer to print the print information on the next print medium when the printed print medium exposed from the outlet has been removed.

8. A method for controlling a printer that sequentially feeds a plurality of print media toward an outlet and performs printing on the print media, the method comprising:
printing print information on the print medium;
feeding the printed print medium until the printed print medium becomes exposed from the outlet;
outputting, as voice, at least a part of the print information or information related to the print information when the printed print medium exposed from the outlet has been removed; and
printing the print information on the next print medium when the printed print medium exposed from the outlet has been removed.
